(19) United States
(12) Patent Application Publication
(10) Pub. No.: US 2017/0188023 A1
(43) Pub. Date: Jun. 29, 2017

(54) Method and system of measuring on-screen transitions to determine image processing performance

(71) Applicant: Intel Corporation, Santa Clara, CA (US)

(72) Inventors: CHARLES BRABENAC, PORTLAND, OR (US); SEAN J LAWRENCE, BANGALORE (IN); ANKITA TAPASWI, PUNE (IN)

(21) Appl. No.: 14/998,195

(22) Filed: Dec. 26, 2015

(51) Int. Cl. H04N 17/02

(52) U.S. Cl. CPC H04N 17/02

(57) ABSTRACT

A system, article, and method of measuring on-screen transitions to determine image processing performance.

### BACKGROUND

For many image display devices such as televisions, computers, tablets, and smartphones, the display device processes image data in the form of color (or chroma) and luminance data for numerous pixels that form the image. One way to assess the performance of the imaging processes is by observing the screen to determine exactly when the images are provided on a screen of the display. This was accomplished by using a high speed camera in order to achieve sample rates that were higher than a video display rate in order to determine when frames for a video sequence were displayed. This solution, however, was often prohibitive because such high speed cameras are very expensive.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a side cross-sectional view of a sensor unit on a display screen in accordance with the implementations herein;

FIG. 2 is a diagram of a transition detection unit for a system of measuring on-screen transitions to determine image processing performance;

FIG. 3 is a flow chart of a method of measuring on-screen transitions to determine image processing performance;

FIGS. 4A-4B is a detailed flow chart of a method of measuring on-screen transitions to determine image processing performance;

FIG. 5 is a diagram of a system for measuring on-screen transitions to determine image processing performance on multiple display devices of a network;

FIG. 6 is a bottom view of a light detecting device for mounting on a display screen in accordance with the implementations herein;

FIG. 7 is a diagram of a system for measuring on-screen transitions to determine image processing performance on a single device with a display;

FIG. 8 is a schematic diagram of performance indicator patterns used for measuring on-screen transitions to determine image processing performance on a single device with a display;

FIG. 9 is a schematic diagram of a system for measuring on-screen transitions to determine image processing performance on a single display device of a network with multiple display devices; and

FIG. 10 is a flow diagram of a system in operation performing a method of measuring on-screen transitions to determine image processing performance;

FIG. 11 is an illustrative diagram of an example system; and

FIG. 12 is an illustrative diagram of another example system.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as laptop or desktop computers, tablets, mobile devices such as smart phones may be used as part of a measurement tool described herein and may be part of, or form, a transition detection unit. Also, the measurement tool may be mounted on, or positioned in front of, a device that has a display screen for viewing videos and may be formed of the components and/or platforms just mentioned as long as the device has a screen to show videos. Thus, this may also include other small wearable smart devices such as smart watches. These may be used to implement the techniques and/or arrangements described herein. This includes stand-alone display devices as well as one or more display devices on networks. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. Material disclosed herein may be implemented in hardware, firmware, software, or any combination thereof.

Material disclosed herein also may be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Systems, articles, and methods of measuring on-screen transitions to determine image processing performance.

As mentioned, there are many electronic display devices that display digital videos or still images such as televisions, laptop or desktop computers, tablets, smartphones, and even smaller devices such as wearables that have display screens such as smartwatches. It is desirable to measure or assess the performance of the display and the systems that process the image data typically in the form of chroma and/or luminance pixel data for image frames of a video sequence for example.

One conventional solution is to use a high speed camera that should be set with a higher sample rate than the frame rate for the video sequence being monitored. More accurately, the desired sample rate (or resolution accuracy) is approximately equal to the inverse of the camera capture frame rate, typically of the order of 30 fps to 240 fps (or 33 ms to 4 ms per capture) resolution for accuracy. Some very expensive cameras can reach 1000 fps. To achieve these rates with a camera based solution, the high speed cameras can be very expensive and are not affordable. The relatively slower cameras that come closer to affordable still may not have a sufficient resolution (or capture frame rate) for high quality video displays that use 60 fps or more.

To resolve these issues, a method and system is used to measure on-screen transitions in color and/or luminance that in turn can be used to measure various video and imaging performance indicators. This involves the use of sensors, such as light sensors or photodiodes, placed in front of a display screen. Images are displayed on the screen and have modified content to intentionally include one or more light patterns (also referred to herein as embedded markers). The patterns are positioned in the image content to display in front of the light sensor(s). The sensors detect the transitions between color or luminance or both in the patterns. Specific colors, rather than simply transitions between large changes in color or luminance, could be detected by high end photodiodes of fiber optics, but these solutions also are cost prohibitive. Thus, such a pattern easily detected by low cost photodiodes may be one or more areas of the image that change luminance and/or color from frame to frame of the video sequence that is being displayed. Since the sensor(s) are able to detect the change in color and/or luminance from frame to frame, patterns can be provided so that the sensor detects when a new frame is first displayed, the order of the frames, and how long a frame was displayed.

These measured transitions then can be used to measure various performance indicators such as latency between the time an image is displayed on a source device (such as a smartphone) that transmits the video to a remote device (such as a television) for display in a personal area network (PAN). When the measured transitions indicate the frame order, the system can determine whether frame drops or frame repeats occurred. When the measured transitions indicate how long a frame was displayed, it can be determined which frames are lingering too long on the display screen whether a frame repeat or lingering for less than an entire frame period. The details are provided below. It will be understood that the term frame may be used interchangeably with image and picture, and may refer to the content of the image, while screen refers to the physical components (or hardware) that displays the frame. The frame characteristics than may be used to compare and/or improve imaging processes.

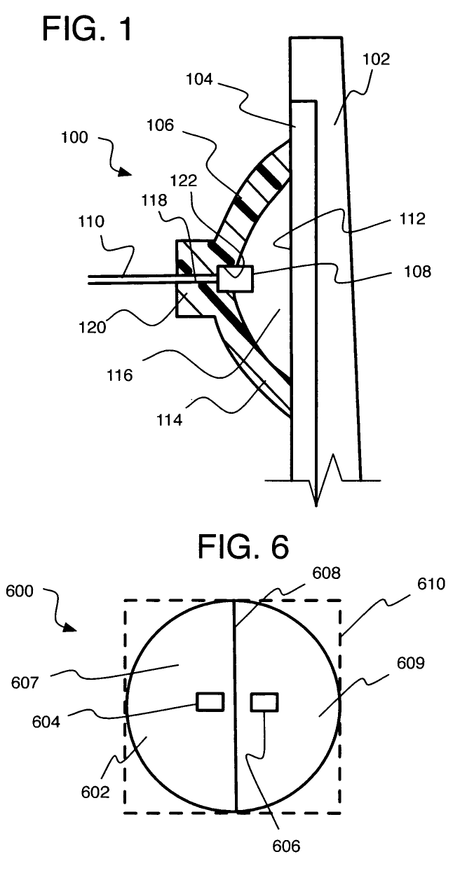

Referring to FIG. 1, an on-screen transition measuring system 100 is shown disposed in front of a display device 102 with a screen 104, and may have at least one example sensor unit 106 mounted on an outer surface 112 of the screen 104. As explained below, the system 100 may have multiple sensor units 106 mounted on a single display or each mounted on different displays as well. The display device 102 may be just about any electronic device with a display screen and that displays video images using color or luminance image data for pixels. Thus, this may include displays of many sizes from large screen televisions to smartwatches, and including smartphones, tablets, laptops, all-in-one lap tops, computer monitors, and so forth. The size of the sensor unit 106 may vary with the size of the display device, and in turn, the size of the pattern that will be shown on the screen of the display device.

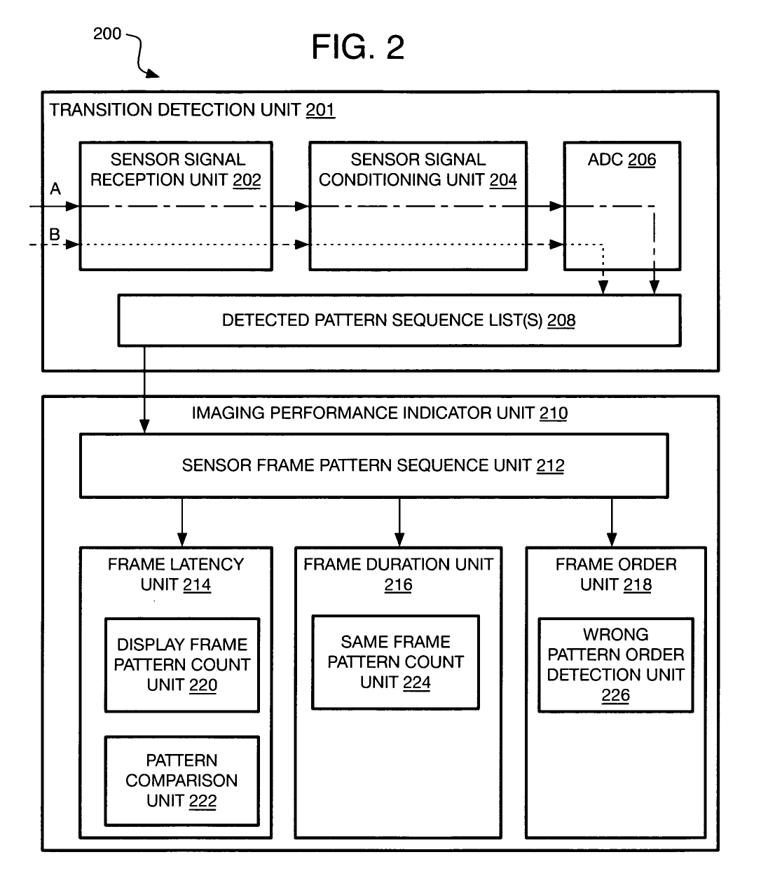

The sensor unit 106 has a light sensor 108 with a connection 110 (here a hard wire) that connects to a transition detection unit (shown on FIG. 2). The light sensor 108 may be one or more photodiodes such as TEPT5600 from Vishay Intertechnology, Inc. that detects luminance (or grayscale). This type of photodiode provides at least an angle of sensitivity and the photocurrent adequate for detecting the pattern. More details are provided with FIG. 2.

The light sensor 108 may be held on the inside of a concave body 114 of the sensor unit 106 and that forms an enclosed chamber 116 between the body and the screen 104. The chamber 116 blocks or limits light from external light sources. Alternatively, the light sensor 108 may simply be placed within the chamber 116 or held in the chamber by other mechanisms. In the present example, the wire 110 extends from the light sensor 108 to outside of the body 114 through a channel 118 in a thickened or central portion 120 of the body 114 that also may have a space 122 to hold the light sensor 108. The body 114 should be shaped to form a tight seal against the surface 112 of the screen 104 to hold the light securely to the display, and so that as little light from other external light sources other than the screen as possible enters the chamber 116 during testing to limit the amount of light from those other sources that infiltrates the sensor signals as noise.

By one example form, the body 114 is a hemispherical suction cup made of plastic, rubber, or other suitable materials that adequately blocks light and forms a temporary seal with the screen by suction or the formation of a vacuum, thereby blocking out a significant amount of light from sources other than the screen directly in front of the body 114. Alternatively, the body need not always be circular, and in fact may be square or rectangular to better match a shape of a pattern shown on the screen. Also, a body of the sensor unit may be attached to the screen using other connectors or mediums such as a vise or relatively weaker adhesives including glues, pastes, or tapes, or even stronger or more permanent connections when removal of the body 114 from the screen 104 is not a concern.

By other examples, the sensor unit 106 may not be mounted to the screen 104. Instead, the sensor unit simply may be disposed in front of the screen 104, and otherwise held adjacent or against the screen 104 for a sufficient time for running the video sequence.

Referring to FIG. 2, an on-screen transition measuring system 200 that has a transition detection unit 201 to provide detected pattern sequence data or lists as detected by the one or more sensor units 100, and that are provided to an imaging performance indicator unit 210 that uses the detected pattern sequence data in computations to determine frame characteristics of the frames displayed in the video sequence in front of the sensors, which in turn provides performance indicators of the imaging system.

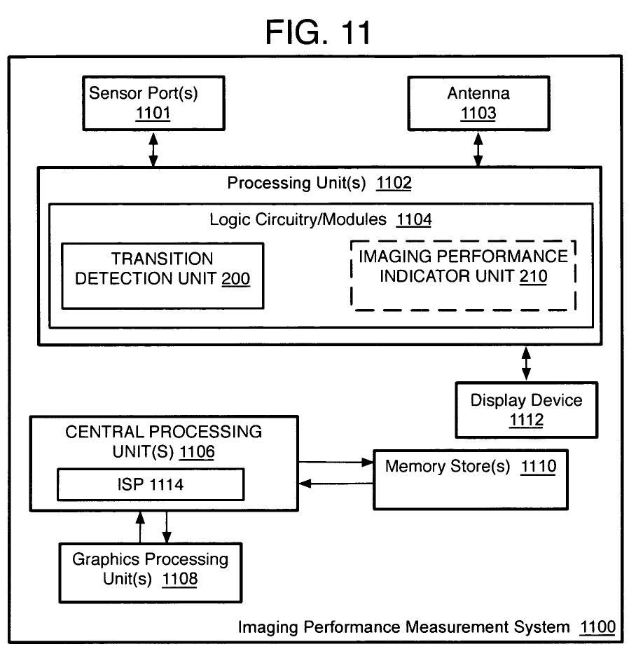

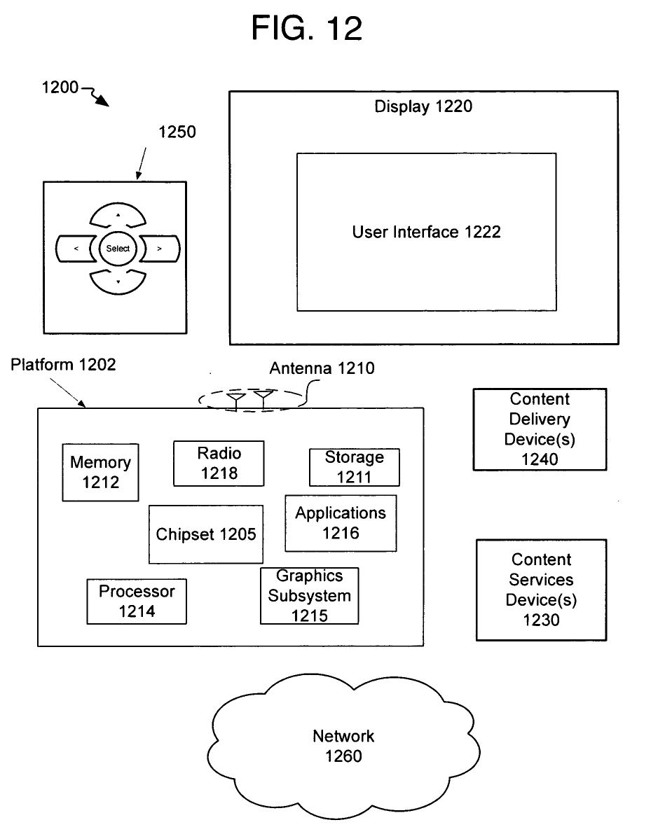

The transition measuring unit 201 may be in the form of an electronic device or computer that is separate from the one or more display devices being tested, but alternatively could reside on such display device. Otherwise, the transition measuring unit 201 may be, or may be considered to reside on, a computer, a desktop computer, server, laptop, tablet, smartphone, and so forth, and may have its own display or be attached to a display to render the resulting data. Likewise, the imaging performance indicator unit 210 may be a part of the transition detection unit, or may be considered to be a separate unit, and may or may not be on a separate device, including any of those mentioned for the transition detection unit 201. The form of the transition detection unit 201 and imaging performance indicator unit 210 are not particularly limited as long as the transition detection unit 201 can receive the sensor data and can communicate with the imaging performance indicator unit 210 as described below. Some other example implementations of these units are also provided by systems 1100 and 1200 (FIGS. 11-12) described below.

The transition detection unit 201 may have a sensor signal reception unit 202 to receive the sensor signals, a sensor signal conditioning unit 204 to refine the signal, and an analog to digital convertor (ADC) 206 to convert the signal to digital values that represent the detection of certain color or light intensity levels. The values from each sensor, and from each video sequence, then may form a detected pattern sequence list 208 that can be stored in a memory.

In more detail, the signal reception unit 202 is shown in the examples herein to directly connect the sensor unit(s) to the transition detection unit by wires to limit the expense. Such connection may be permanent and connect directly to circuit boards on the reception unit 202. Other analog signal ports may be used as well. Otherwise, the connection may be wireless connections where the sensor unit and signal reception unit may have antennas and provide one-way or two-way wireless communication over, a PAN with a WiDi connection, or Bluetooth for example. Also, the sensor unit(s) and transition detection unit may be wirelessly and/or wire connected by larger networks such as a local area networks (LANs) or wide area networks (WANs) such as the Internet or WiFi. Other example details and implementations are provided below.

The sensor signal conditioning unit 204 may amplify and/or otherwise perform other pre-processing denoising algorithms on the analog sensor signal to prepare it for the ADC unit 206. An opto-de-coupler also may be used to decouple the signals from a converter to prevent current surges.

The ADC unit 206 receives the analog signal and then converts each sensor sample, such as at every 1 ms, to a digital value. By other forms, the time duration can be reduced even further if desired since the sampling frequency is flexible and set for the limits of the microcontroller involved. By one form, and as explained in greater detail below, two different pattern stimuli are used, black or white (or dark or light) so that the photo diode remains off (or detects very little light) when the stimuli is dark (low light intensity) or black, and turns on (or detects strong light) when the stimuli has high light intensity or is white. When the signal indicates the light sensor is off or little light is detected, this is quantized to a 0, but when the signal indicates the light sensor is on or indicates a high light intensity, then this area of the signal is quantized to 1. As explained below, other options are possible where more light levels may be detected.

With this arrangement, the output of the ADC provides sequences of 0s and 1s that indicate which pattern stimulus was detected for each single sensor sample. Thus, the ADC will output a detected pattern sequence list 208 for each video sequence and for each pattern of single stimuli on the frames of the video sequence. As shown, in cases where multiple light sensors are provided, such as two light sensors including one light sensor on a source display device and another light sensor on a destination or remote display device, in this case multiple signals may be received, such as signals A and B as shown. For clarity, it may be considered that each signal generates its own detected pattern sequence list, and each sequence of single stimuli placed in front of the same light sensor from frame to frame is considered a single pattern, even when multiple stimuli exists on the same frame. Thus, this situation will be referred to as showing multiple patterns where each light sensor tests a different pattern to avoid confusion. In other words, as shown in FIG. 8 below, a 2-bit gray code sequence may be displayed on the frames where two pattern stimuli are shown on each frame, but will be referred to as two patterns, where each pattern is placed under a different light sensor. Other details are provided below. The memory for storing the pattern sequence lists, such as RAM, is not particularly limited and example implementations are provided below.

As mentioned, the imaging performance indicator unit 210 may part of the transition detection unit 201, or may be, or may be on, a separate device that communicates with the transition detection unit 201 to receive the detected pattern sequence lists. The imaging performance indicator may be operated by a microcontroller such as a System on Chip (SoC) such as LabJack U3-LV, Audrino, Gallile, Edison and others an d arrange to operate as described herein. The imaging performance indicator unit 210 may be provided to determine one or more frame characteristics, and may provide the option to a user to select which frame characteristics to compute, or the selection may be set automatically. The retrieval of sensor data from a sensor such as a photodiode connected to an analog to digital converter and microcontroller as described herein would be a low cost solution and have greater accuracy for measurement due to the possibility of using high frequency sampling of the sensor output, such as 1 kHz or greater, or 1 ms or less, resolution (or sampling rate of the sensor using a photodiode) for high accuracy as described herein.

The imaging performance indicator unit 210 may have a sensor frame pattern sequence unit 212 that may store the pattern sequence lists if the memory of the transition detection unit is not available, and may otherwise organize the pattern sequence lists for convenient retrieval. This is used for frame duration or frame sequence type of analysis, and may stored the sequence lists as a look up table of strings such as [′00′, ‘01’, ‘11’, ‘10’] and so forth.

The imaging performance indicator unit 210 may provide a frame latency unit 214, a frame duration unit 216, and/or a frame order unit 218 that detects dropped or repeated frames. The frame latency unit 214 may be used when multiple light sensors are used to generate multiple signals, and in turn, multiple detected pattern sequence lists as in the case with a PAN where a source display device displays a video and transmits the video to a destination display device for display as well. For this situation, the frame latency unit 214 may have a display frame pattern count unit 220 that determines which pattern sensor sample value in the multiple pattern sequences for the two different display devices correspond to the same frame. A pattern comparison unit 222 then compares (or differences) the time points along the pattern sequences of the sensor sample values of the same frame to determine a latency between the display of the frame on the two display devices. The details are provided below.

The frame duration unit 216 may have a same frame pattern count unit 224 that determines how many consecutive change sensor samples have the same pattern values. In other words, it determines when a change in value occurs indicating an end of a frame after a change in value that indicates a start of a frame. When light sensor sampling is provided at 1 ms, and frames are played at 30 fps, every about 33 sensor samples should correspond to a frame. When the count (or duration) is greater than this, the frame is lingering too long on the display, and when less than about 33, the frame is not being displayed long enough.

The frame order unit 218 determines whether there is an error in the order of the frame which indicates a frame was repeated or dropped. Thus, a wrong pattern order detection unit 226 is provided and that seeks consecutive sensor sample value changes from one set of pattern values to another set of pattern values that are not in the correct order according to the pre-determined expected patterns provided on the frame content. When this occurs, one or more frames were dropped. Otherwise, when the same sensor sample values continue over a number of samples that should cover more than an additional one or more frames, this is considered frame repetition of the same frame. When such duration over sensor samples is greater than a single frame but less than an entire additional frame, this is simply considered a lingering frame duration mentioned above. More details about the operations of the imaging performance indicator unit 210 are provided below.

This frame characteristic data then may be used by other applications, or displayed to a user, to compare or improve imaging systems being used.

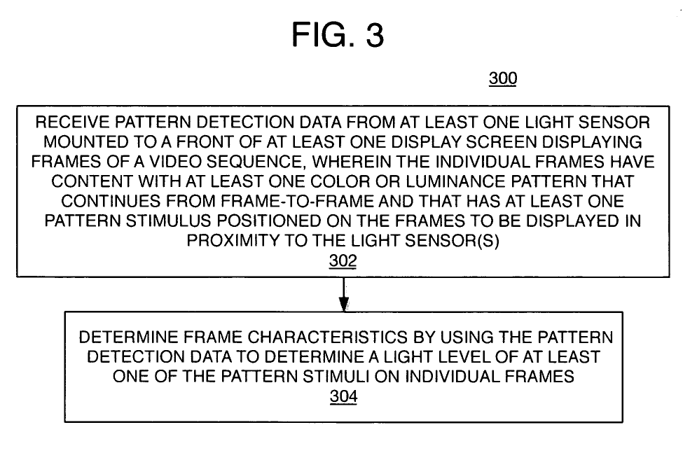

Referring to FIG. 3, an example process 300 provides a computer-implemented method of measuring on-screen transitions to determine image processing performance. In the illustrated implementation, process 300 may include one or more operations, functions or actions as illustrated by one or more of operations 302 and 304. By way of non-limiting example, process 300 may be described herein with reference to example on-screen transition measuring systems described herein and with any of the implementations presented herein, and where relevant.

Process 300 may include “receive pattern detection data from at least one light sensor mounted to a front of at least one display screen displaying frames of a video sequence, wherein the individual frames have content with at least one color or luminance pattern that continues from frame-to-frame and that has at least one pattern stimulus positioned on the frames to be displayed in proximity to the light sensor(s)” 302. Thus, a light sensor, such as a photodiode, is positioned in front of a display screen where the frames of a video sequence will have content including pattern stimuli to be detected by the sensor. By one form, this may include an alternating pattern of black and white (or high intensity light and low intensity light), and this pattern may be used on multiple display screens playing the same video content with the same pattern where each screen has a light sensor to detect the pattern. By another form, multiple patterns are provided that run frame to frame so individual, or each, frame has multiple pattern stimuli where each stimulus is positioned near its own light sensor on the display screen.

Process 300 then may include “determine frame characteristics by using the pattern detection data to determine a light level of at least one of the pattern stimuli on individual frames” 304. Specifically, the photodiode will turn on or off, or provide low and high frequencies, that provides a signal that can be quantized by an ADC to 1 or 0 to represent the alternating pattern. Once the sensor signals are converted to digital by an ADC, the results are one or more detected pattern sequence lists of sensor sample values that can be used for frame characterization and in turn, imaging performance indicators. The details are provided below. Particularly, the pattern value sequences can then be used to determine frame latency for example in the case where multiple pattern value sequences are provided, one from a source display device and another from a destination display device that received the video content or sequence transmitted from the source display device, such as in a PAN. In this case, the transitions or changes in pattern value can be used to determine the start time, or sensor sample time point, that indicates the start of a frame on both devices. The start points can then be differenced to determine a latency for individual frames. This can be repeated for each frame in a video sequence. Additionally, frame duration or frame repeats can be determined by determining how many consecutive sensor samples have the same stimulus (or sensor sample value) when multiple patterns are provided on the frames at a single display device. When the same values (such as (1, 1), or black and black) are provided on numerous consecutive sensor samples covering a current frame but less than an entire or extra additional frame, this is a lingering frame that lingers for less than an entire frame period, but when the values are the same for one or more additional frame periods, this is a frame repeat. Otherwise, frame drops may be determined by determining where the change in sensor sample value from one sensor sample point to another does not change in the correct pattern order. This indicates one or more skipped frames. Again, the details are provided below.

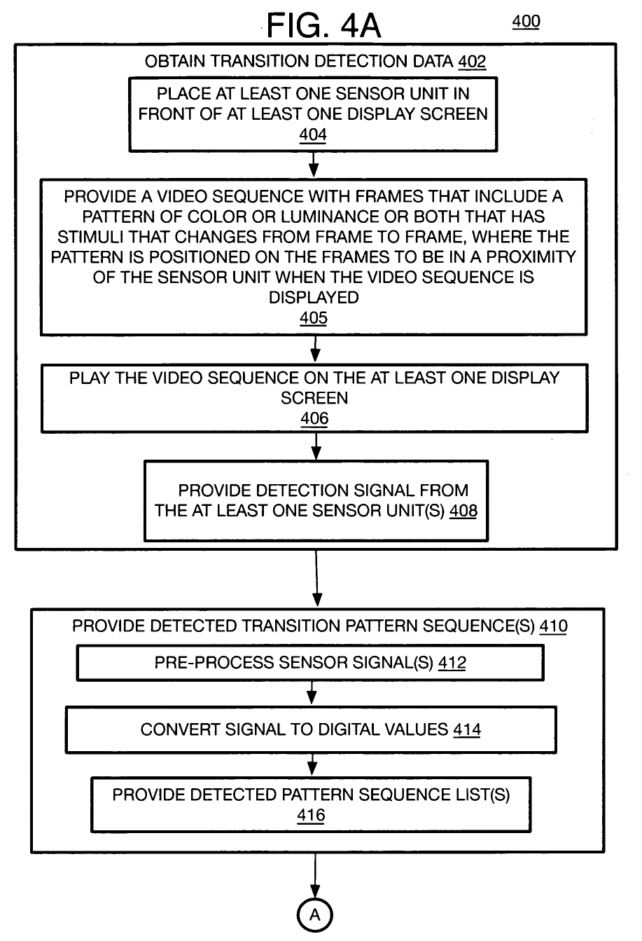

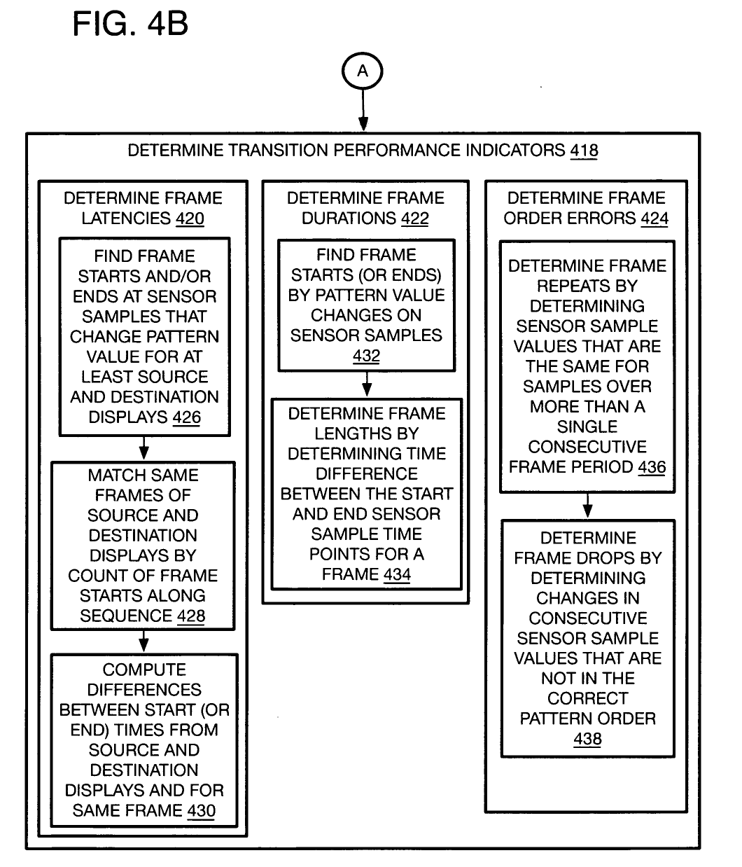

Referring to FIGS. 4A-4B, an example process 400 provides a computer-implemented method of measuring on-screen transitions to determine image processing performance. In the illustrated implementation, process 400 may include one or more operations, functions or actions as illustrated by one or more of operations 402 and 438. By way of non-limiting example, process 400 may be described herein with reference to example on-screen transition measuring systems described herein with any of the implementations presented herein, and where relevant.

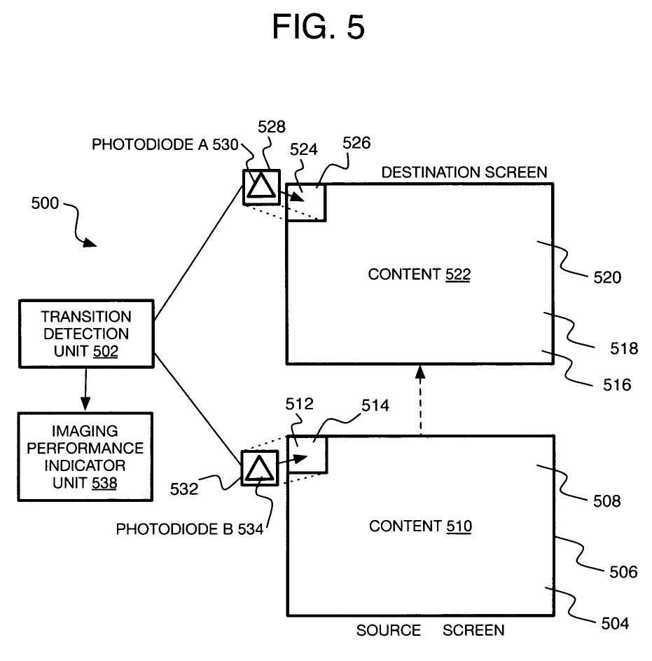

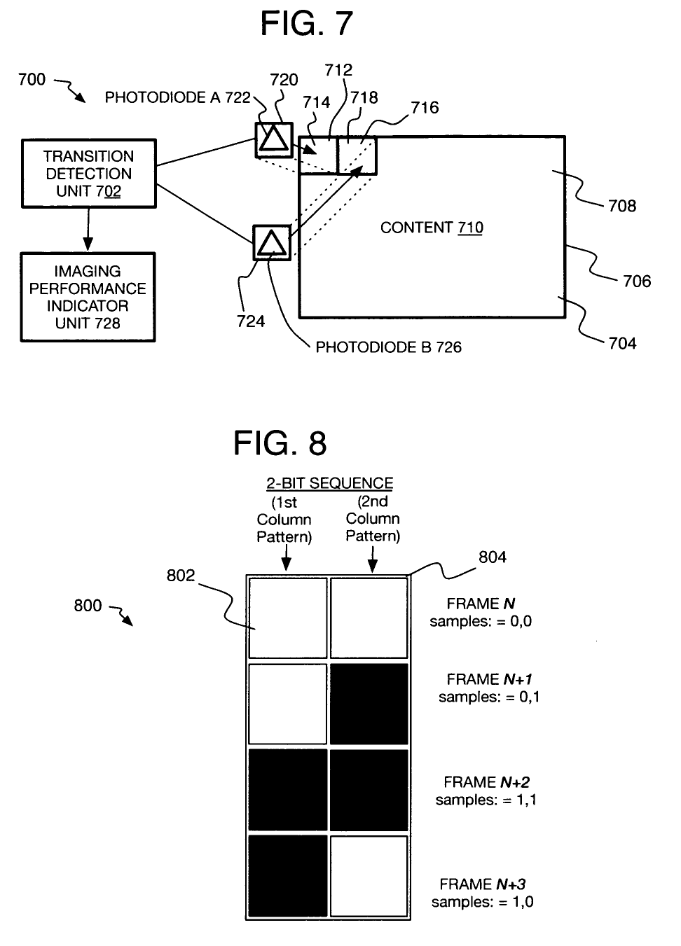

Process 400 may include “obtain transition detection data” 402, and first may include “place at least one sensor unit in front of at least one display screen” 404. Thus, the on-screen transition measurement system may be arranged in a number of different ways depending on the type of media network that is being analyzed and the performance indicator that is being sought. By one example form, the system has two sensor units so that each sensor unit may be placed on a different display device such as in a PAN (as shown by FIG. 5) in order to determine the frame latency from a source display device to a destination display device. Alternatively, both sensor units could be placed on the same single display device (as shown by FIG. 7 for example) so that multiple patterns can be used to determine frame durations or frame order errors such as frame drops or frame repeats. These arrangements are described in more detail below with the description of the patterns on the frames. It also will be appreciated that more than two sensors could be used. Many variations exist.

Also as mentioned, the light sensor may be photodiodes held in front of the display device, and by one form, secured to the display device inside a body that blocks external light as much as possible such as with suction cups as described with system 100, but other variations could be used. The photodiodes are able to provide sensor samples (or resolution) at every about 1 kHz or 1 ms that provides about 33 samples per frame period for video played at 30 fps. Photodiodes have been tested and used from 60 Hz to 10,000 Hz.

Process 400 may include “provide a video sequence with frames that include a pattern of color or luminance or both that has stimuli that changes from frame to frame, where the pattern is positioned on the frames to be in a proximity of the sensor unit when the video sequence is displayed” 405. As mentioned, the system may be arranged in a number of different ways, and the pattern may be different depending on the arrangement. Some possible arrangements and the patterns used for those arrangements are explained below.

Referring to FIG. 5, an on-screen transition measuring system 500 may test the imaging on a personal area network (PAN) with multiple display devices in order to monitor the frame latency. Specifically, a number of short-range or PAN mirroring systems transmit video and/or audio-video (AV) files, or otherwise what is viewed on the screen and audible on a transmitting device, and typically to a remote receiving device that is more convenient or provides a better experience for viewing or listening to the video and/or AV. For example, a movie may be played or processed on a smartphone while viewing the video of the movie on a large television. In other examples, the screen of a laptop may be transmitted to a conference room projector, or a cable box may transmit a show to a smaller device such as a tablet in addition to, or instead of, the television. Other examples include short range wireless displays with wireless docking. These systems are often described as wirelessly replacing the connection wire from the computer to the display. Many examples are possible.

Such video transmission between a source display device and destination display device may operate in the 2.4 GHz and/or 5 GHz band (e.g., Wi-Fi 802.11n), and in some forms, in the 60 GHz band. Such transmission may further support and/or comply with one or more High Definition Media Interface (HDMI) protocols, such as Wireless Home Digital Interface (WHDI), Wireless Display (WiDi), Wi-Fi Direct, Miracast, WirelessHD, or Wireless Gigabit Alliance (WiGig) certification programs, and so forth.

The arrangement here includes a source display device 504 with a source display screen 506 displaying a frame 508 of a video sequence and that has content 510 with a stimulus 512 that is part of a pattern 514 that continues on multiple frames, and in one form, frame-to-frame and each frame. The pattern 514 is shown to be placed in the upper left corner of the screen 506 but could be placed anywhere convenient on the screen as long as a sensor can be placed in front of the pattern 514, and particularly when a sensor unit is to use a suction cup as described herein. By one form, one of the corners of the screen is selected assuming it is the best position to avoid interfering with the other content 510 in the image or frame. By other forms, it may be more convenient for attaching a sensor unit to a corner of the display device 504, such as by clamps, tapes, or other mechanisms.

The display device 504 also may transmit the video sequence with the pattern on the content of the frames to a destination or remote display device 516 with a display screen 518 that shows the frames 520 with the content 522 that includes the stimulus 524 of the pattern 526, which is the same as pattern 514.

As to the pattern itself, in order to test for frame latency, the pattern may include flashing or alternating black and white squares or rectangles. As mentioned, the black may be formed from the color black or minimum (or zero grayscale) light intensity, while the white may be formed from the color white or maximum (255 grayscale) light intensity. The pattern alternates so that any two consecutive frames have a different color or luminance. Thus, as mentioned, when 1 ms light sampling is provided by the light sensor unit, the frame period covers about 33 sensor sample values that will remain the same for a frame period before changing for the next frame. By other alternatives, the pattern and the sampling could be different when less sampling is to be used. In these cases, for example, the alternating may occur in intervals such as every 10 frames but the greater the interval, the less accurate the results may be.

As to the shape of the stimulus, any convenient shapes may be used such as circular or other shapes, and may be formed to match the shape of the body of the sensor unit that will cover the stimulus. The shape of the sensor unit need not always be the same shape as long as the stimulus provides a sufficient amount of light so that the changes in light can be detected by the light sensor. Thus, while the sensor unit body may be circular, the stimulus may still be rectangular and so forth. Thus, the stimulus may or may not have an area larger than the area on the screen that is enclosed by the sensor unit body. The stimulus also may have different shapes depending on screen size and shape, and other form factors, and may or may not be the same for each frame. Many variations exist. This applies to any of the implementations described herein.

The size of the stimulus and in turn corresponding size of the sensor unit body for any implementation herein, may depend on the size of the screen being tested. Thus, by one example, the stimulus may include up to about 65 pixels on a screen of size 1920×1080 resolution for six inch screen (measure diagonally) when the light sensor (photo diode) is about 3/16″ diameter. Smaller photodiodes and sensor units may be used to test images on a smartphone for example.

In the present example of the PAN system, two sensor units 528 and 532 are provided each with its own light sensor such as a photodiode 530 and 534, respectively, that are placed over the stimulus area 524 and 512, respectively. The two light sensor units 528 and 532 are both attached by wire or wireless communication to a transition detection unit 502 which may have or communicate with an imaging performance indicator unit 538. These components are described in greater detail below.

Referring to FIGS. 7-9, alternative systems 700 and 900 may provide multiple light sensor units on a single display device 704 with a display screen 706 that shows a video sequence with frames 708 that have content 710 including at least two stimuli 712 and 716 respectively of two patterns 714 and 718 that are provided frame to frame over a video sequence. The patterns 714 and 718 are to be placed under the sensor units 720 and 724 respectively. The sensors units 720 and 724 each may have a photodiode 722 and 726 respectively, and may be communicatively connected to a transition detection unit 702, which in turn may have or be communicatively connected to an imaging performance indicator unit 728.

For this arrangement, two stimuli 712 and 716 are placed next to each other, but alternatively may be placed on the content 710 anywhere in the screen 706 that is convenient. Thus, the two stimuli 712 and 716 could be spaced apart on the screen.

Referring to FIG. 6 as one option, when the stimuli 712 and 716 are placed next to each other, the two sensor units 720 and 724 could be placed under the same sensor body. Thus, for one possible example, a sensor unit 600 may have a suction cup body 602 with two light sensors 604 and 606 divided by a wall 608 to create two separate light excluding chambers 607 and 609 respectively, one for each of the light sensors 604 and 606 so that the light sensors can separately detect light from the two stimuli 712 and 716. A dashed outline 610 is provided to show that the body 602 could be rectangular instead of circular.

Referring to FIG. 8, as mentioned, two patterns are provided here each pattern providing a stimulus on each frame to form an overall 2-bit sequence as shown. The sequence includes four frame periods in this example, and by one form, this may be a grayscale code sequence but could be changes in color instead (or additionally). Thus, the 2-bit sequence provides a repeating cycle of four different frame period combinations. This includes a combination of a first column stimulus and a second column stimulus respectively designated as white-white at a frame N (which will digitize to (0, 0) for the sensor samples of that frame period), then white-black (0, 1) at frame N+1, black-black (1, 1,) at frame N+2, and then black-white (1, 0) at frame N+3 where the white and black may designate light intensity or color. The pattern creates at least one stimulus transition from black to white, or vice versa, with each new frame in the video sequence. Also, since each frame period combination may cover a number of sensor samples or sample periods (such as about 33 sensor samples at each frame period), it can be determined when frame durations are too long or too short, or when frames are repeated and/or dropped by finding the changing sensor sample values in the detected pattern sequence lists as described below.

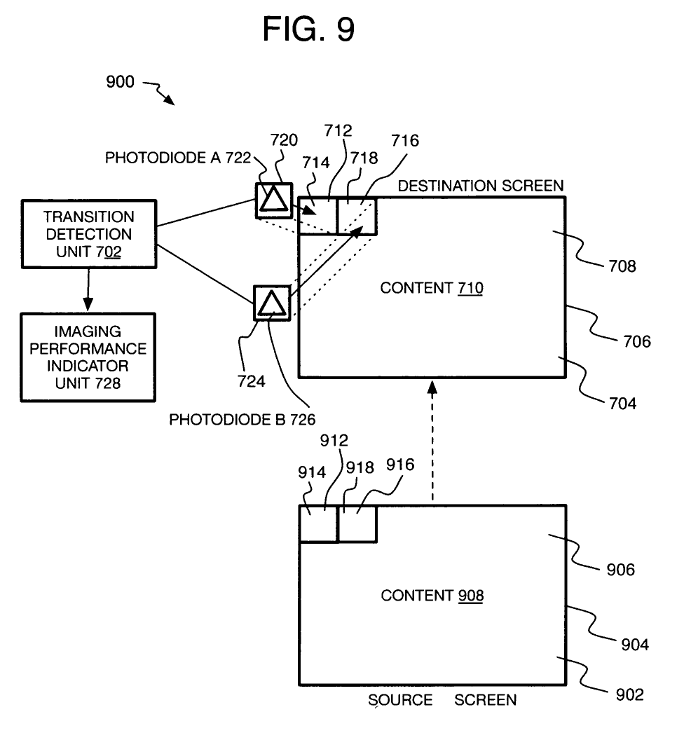

Referring to FIG. 9, a system 900 has the same arrangement as system 700 on display device 704 and with transition detection unit 702 and sensor units 712 and 716, except here the display device 704 may be part of a PAN such that the video sequence is provided from a source display device 902 with a display screen 904 that also displays frames 906 of the same video sequence playing on the display device 704. Thus, the frames 906 have content 908 that includes two stimuli 912 and 916 of patterns 914 and 918 that are the same as that for patterns 714 and 718 on the frames 708.

Process 400 may include “play the video sequence on the at least one display screen” 406, and as described, with either one stimulus on multiple screens, or multiple stimuli on a single screen so that each sensor unit can be placed over a stimulus. Thus, this may include a number of preliminary operations including first placing the sensor units over the area that will show a pattern stimulus on each display screen being used whether a single screen that has two or more sensor units as with system 700 and 900, or multiple screens each with at least one sensor unit as in system 500, and as described in detail above.

The sensors, such as a light sensor or photodiode may remain off or may detect very little light when the color is black or light intensity is minimal, and may be turned on or detect a high light level when the color is white or the light intensity is high. The actual detection may provide a signal of a range of light levels that are then quantized to 0 (for black) or 1 (for white). As described herein, the two levels are all that may be needed for the frame characteristics that are being determined. Thus, since the pattern only provides these two options (black or white), it is fairly safely assumed that quantizing the sensor signals to two values is sufficiently accurate. Alternatively, however, since there are a relatively large number of sensor samples per frame period, the system is capable of being even more accurate. Thus, multiple light levels could be used to determine transitional related durations or in other words, how long it takes (over how many sensor sample periods) to transition between the minimum color level for black and the maximum color level for white for example. It could happen relatively instantly, within 1 ms from one sensor sample to the next, or it could happen over a greater number of sensor samples, and therefore more than 1 ms per sample to better ensure accuracy even further. This data could be used to raise the efficiency of the imaging even further.

Once the sensor units are place in front of the display device screen(s), the video sequences may be played and the light sensors may be activated to transmit a detection signal. This may be provided for a time period that depends on the measurements desired. Thus, if it is a quick setup test to determine whether a video is transmitting and playing properly, the test may include capture (or detection) of patterns over a few seconds or one or a few minutes. If the test is being provided to monitor during movie playback for example, then the pattern capture should be from two-three hours or however long the playback continues. A light sensor, such as a photodiode, converts different light levels into different levels of current, and the detection signal then may be formed as a signal of current levels, as indicated by signal amplitude characterized by brightness of the screen, and over time.

Thereafter, process 400 may include “provide detection signal from the at least one sensor unit(s)” 408, and as described, the signal may be an analog signal from each sensor unit. The signal(s) may be provided directly to the transition detection unit by wires or other communication mechanism.

Process 400 may include “provide detected transition pattern sequence(s)” 410. This includes a number of operations to convert the analog signal to digital sensor sample values that can be used to assess frame characteristics.

Accordingly, process 400 may include “pre-process sensor signal(s)” 412. Once the signal is transmitted from the sensor unit(s) and received to be used to determine frame characteristics, the signal may be pre-processed including conditioning such as amplification, denoising, and other operations to refine the analog signal. Signal pre-processing also may be used to build an indicative map of samples as opposed to always processing all 1000 samples per frame.

Thereafter, the process 400 may include “convert signal to digital values” 414, and as mentioned, this may include quantization of the signal by an ADC to either 0 or 1 when only two light levels should be detected from the patterns that are provided. When the system 500 is used for PANs, this includes converting two separate signals and forming a separate digital sequence for each signal (also referred to as a sequence of sensor sample values or detected pattern sequence list), and in turn for each display device. For systems 700 and 900, the two pattern signals are converted and can either be kept as separate detected pattern sequence lists thereafter, but alternatively could be formed into a single combined detected pattern sequence list that includes a 2-bit sensor value combination that represents individual frames as explained herein. This combined sequence list may list both detected values for a frame consecutively so the list is organized frame by frame first, or otherwise could simply have the two lists from the two sensors concatenated one after the other as provided first by one light sensor and then the other light sensor.

Process 400 may include “provide detected pattern sequence list(s)” 416, such that the detected pattern sequence lists may be provided in a memory where it is accessible to determine frame characteristics using the detected pattern sequence lists. As mentioned, this could be on or at the transition detection unit, imaging performance indicator unit, or both, or somewhere else accessible for both units. Alternatively, each sensor unit may have its own transition detection unit to convert its sensor signal to digital values before transmission of the values to an imaging performance indicator unit.

Process 400 may include “determine transition performance indicators” 418, and particularly, to use the sensor sample values in the detected pattern sequence lists to determine frame characteristics such as frame latency to determine video playback quality for a PAN system, and frame duration and/or frame order errors such as frame drops or frame repeats when testing a single display device. The detected pattern sequence lists could also be used to determine other frame characteristics.

Turning first to the PAN systems, process 400 may include “determine frame latencies” 420 and between the rendering of the same frame on the source display device and the destination display device. Frame latency is important to monitor because it is difficult if not impossible to control the display of a video on a remote device and from a source device when the frame latency is too long. Control from the source device may be desired to pause or fast forward, and so forth on a video, play games, or even move a mouse cursor on the remote screen as controlled on the source screen, as some examples. Frame latency can be caused by delays in the encoding of the video at the source device, transmission problems caused by network load, delays while sorting the video for decoding at the destination or remote device, delays while decoding the video, and delays caused by processing loads while rendering the uncompressed video to name a few examples.

The frame latency operation 420 may include “find frame starts and/or ends at sensor samples that change pattern value for at least source and destination displays” 426. Thus, as mentioned, detected pattern sequences are provided with one sequence for each display and light sensor. Each sensor will have a sequence of 1s and 0s and where the displayed pattern is an alternating pattern of black and white from frame to frame, the detected pattern sequence should be a number of 1s (such as about 33 of them) to cover a single frame period, then 33 0s, then 33 1s, and so on for 1 ms sampling and 30 fps display rate. After the very first sensor sample value indicating the start of the frame and simultaneous start of the light sensor monitoring, consecutive sensor samples along the sequence and that change from 1 to 0 or 0 to 1 (representing the change between black and white) is considered the end of one frame and the start of the next frame. The time points of these change sensor samples (or transition or frame start/end samples) are obtained for both detected pattern sequences from the source and destination display devices for the next operation

Frame latency operation 420 may include “match same frames of source and destination displays by count of frame starts along sequence” 428. For this operation, the system may count, or already list a count) of the frame by start sample. For example, assuming no errors exist in frame order, the fifth change from 0 to 1, or 1 to 0 of sensor sample values in the detected pattern sequence lists from both the list of the source display device and the destination display device should refer to the start of the sixth frame for both lists, and in turn both display devices. This should be true for any frame in the video sequence that was rendered on the source display device as well as transmitted and rendered on the destination display device.

The process 400 then may include “compute differences between start (or end) times from source and destination displays and for the same frame” 430, which is the difference in time or latency from when a frame was shown on the source display device to the time the same frame was shown on the destination display device. Additionally or alternatively, the samples provided during the frame display also may be compared to determine frame synchronization. The system testing may be performed a number of times to attempt to obtain a test with reduced frame order errors (frame drops or frame repeats) which should be sufficiently low to obtain usable results. Dropped or repeated frames are ignored and recorded under their category (dropped or repeat) and the comparisons continue.

Switching to systems 700 and 900, frame characteristics are provided where multiple sensor units are placed on a single display device and where a stimulus of a pattern is disposed on the content of the frames for each sensor unit so that multiple stimuli are provided on each frame as shown by sequence 800 (FIG. 8) by one example. Thus, as one alternative, process 400 may provide “determine frame durations” 422. Frame durations (or lingering or repeating frames) usually indicate a frozen image on the display that should be resolved.

This operation may include “find frame starts (or ends) by pattern value changes on sensor samples” 432. Thus, for this example, the start and/or end sensor sample points are determined along two detected pattern sequence lists (or one list of 2-bit sensor sample value combinations with one combination for each frame). The start and/or end points are determined by finding the sensor sample values along either of the list(s) and where the sensor sample values change from 0 to 1 or 1 to 0 as with the frame latency lists. For sequence pattern 800, this will alternate between the two frames as shown by a portion of the detected pattern sequence lists below for sequence 800 (the number of sensor sample values per frame is reduced here for simplicity):

| | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|
| 0 | 0 | 0 | 0 | 0 | 0 | 0 | 0 | 0 | 0 | 0 | 0 | 0 | 0 | 0 | 0 | 0 | 0 | 0 | 0 | 0 | 1 | 1 | 1 | 1 | 1 | 1 | 1 | 1 | 1 | 1 |
| 0 | 0 | 0 | 0 | 0 | 0 | 0 | 0 | 0 | 0 | 1 | 1 | 1 | 1 | 1 | 1 | 1 | 1 | 1 | 1 | 1 | 1 | 1 | 1 | 1 | 1 | 1 | 1 | 1 | 1 | 1 |

where the top row is an example detected pattern sequence of sensor sample values for the first column of sequence 800, and the second row is the detected pattern sequence of sensor sample values for the second column of sequence 800. Where the last 0 occurs for the second column (bottom row here), this is the end of frame N, and the consecutive sensor sample with the 1 is the start of the next frame N+1 and indicating a change from white to black. It should be noted that the top row (first column in FIG. 8) remains white during the transition from frame N to frame N+1 as shown on sequence 800. The change on the top row from 0 to 1 then indicates the end of the next frame N+1 and the start of a third frame N+2 as well as the change from white to black for the first column of sequence 800, and so on. This is true for each of the frame transitions such that at least one of the detected pattern sequence lists (or one of the stimulus of the combination for a frame) has a sensor sample value that changes for the transition.

Thus, each frame start and end can be determined for frame duration measurement for sequence 800 since the consecutive changing transitions that alternate between the two stimuli are the start and end of a frame. Otherwise, the start and end of the frame respectively may be determined by the sensor sample point that have first and last values of a run of the same values regardless of which stimulus (which column on sequence 800) the first and last values are shown, which indicates a frame period.

Process 400 then may include “determine frame lengths by determining the time difference between the start and end sensor sample time points for a frame” 434. Thus, the time points of the changing sensor samples designated as start and end points for a frame are differenced to determine the frame duration. For sequence 800, it also can be determined when frames are out of order as explained below so that it will be known when the frame duration data is erroneous.

It will be understood that frame duration also could be determined for the PAN system 500 using the detected pattern sequence lists there as well. In this case, two consecutive changes of sensor sample value with the same sensor values repeated between the changes (or in other words, the first and last value of a run of the same value) along the detected pattern sequence lists indicates the change in time, and in turn frame duration, as explained above for the other systems, except here, the frame duration is found for a frame as played on a single display device (source or destination) separately from the frame durations on the other display device in the network being tested.

By another alternative, process 400 may include “determine frame order errors” 424. This may include “determine frame repeats by determining sensor sample values that are the same for samples over more than a single consecutive frame period” 436. Frame repeats may be caused by sampling a display frame buffer before the buffer is updated for example. A frame repeat can be demonstrated by using the sequence 800 as an example. In this case, when both stimuli of the combination provided for each frame in sequence 800 is repeated for a number of sensor samples that cover one or more additional frame periods, this indicates a repeated frame occurred. More specifically, the start of a frame can be determined as already explained for the other options. The system can then count sensor samples from a frame start sensor sample and that cover a frame period (or a time period that should cover a single frame period). For example, assuming frame N is being analyzed, a repeated frame can be recognized when the first and second column stimuli undesirably remain white (for frame N) for greater than what should have been a single frame period, such as about 33 sensor samples, and extends for 33 or more extra sensor samples. A frame repeat is indicated for each extra 33 sensor sample runs. Thus, a stimuli combination of a frame repeated an extra 99 sensor samples (or extra 99 ms) refers to a frame being repeated an extra three times. When the frame duration or extra run beyond a sensor sample point where a transition was expected but is less than a single entire frame period (less than about 33 sensor samples), this indicates a frame lingering for less than an entire frame repeat. Whether the frame is merely lingering or repeats one or more times, this computation may be similar or the same as the frame duration computation of operation 422, such that the determination to find frame duration, lingering frames, and repeated frames may be provided by a single frame length unit.

The PAN system 500 can be analyzed similarly for frame repeats by noting how long (or how many sensor samples) beyond an expected transition the same sensor sample values continue, and whether the same values continue for one or more frame periods as described above.

Process 400 then may include an option to determine when and how many frames are being dropped. Frame drops can be caused by a number of reasons. In order to transmit media that includes video data, a sufficient number of frames associated with packets of video and audio data are stored in a jitter buffer (or more accurately, de-jitter buffer) at the destination (or receiving or sink) device until a decoder is ready to decode the frames. The frames then may be rendered.

Frame drops may occur due to network congestion such as congested WiFi or wireless display (WiDi) networks for PANs, and/or other computational or transaction load factors internal to the transmitter or receiver that may result in a stalled or slow receiver or decoder pipeline that causes delayed frames. A delay may cause frames to be late to the buffer or may cause frames to bunch up and be transmitted with non-uniform timing so that some frames arrive early to the buffer.

If the buffer is small, frames that arrive early at the destination display device are dropped when there is no capacity to hold the frames in the buffer. On the other hand, when the frames are late according to a decoder's clock at the receiver, the frames are still dropped instead of being stored in the buffer, and these late arrival drops may occur regardless of the size of the buffer. Either way, the dropped frames may cause noticeable pauses or annoying breaks in the video being rendered, or may result in difficulty controlling the video on the destination display device by using controls at the transmitter.

To analyze the performance of the imaging system and determine how often frames are being dropped, process 400 may include “determine frame drops by determining changes in consecutive sensor sample values that are not in the correct pattern order” 438. Thus, for the systems similar to systems 700 and 900 that use a multiple bit sequence such as sequence 800 with multiple stimuli on a single frame to form a sensor sample value combination for each frame, it is possible to determine when a frame is being skipped. In more detail, when a multi-stimulus combination is provided on each frame, at least for a certain repeated sequence, the transitions from one frame to the next are unique in sensor sample value sequences (or at least limited) so that a frame drop can be easily revealed.

Referring to the example of sequence 800, for transition from frame N to frame N+1, the sensor sample values of the detected pattern sequence for the first column stimulus will change from 0 to 1, while the sensor sample values of the detected pattern sequence for the second column stimulus will remain 0 (0 to 0). If frame N immediately transitioned to one of the other three frames (frame N+2 or frame N+3), the sensor sample values would be different. For example, if frame N transitions immediately to frame N+2, both the first and second column sensor sample values would change from 0 to 1. This would not be a proper transition combination, and it would be understood that a frame drop occurred. It also would be understood by the sensor sample values that the transition was from a frame N to a frame N+2 if one frame was skipped, or at least a frame N+2 type of frame if the number of frames skipped is a multiple of four. Thus, the same result would occur if multiple frames such as 5, 9, 13, and so on, frames were dropped. The location of the frame in the frame sequence can be determined by recording the pattern changes along the frame sequence from frame to frame where missing pattern counts are recorded as dropped frames.

Other multiple stimuli combination patterns could be used with more or less combinations than that provided by sequence 800 (FIG. 8). The number of stimuli placed in a combination to show on a frame controls how many combinations a repeating sequence will have frame to frame when only using black/white (0 or 1) sensor sample values. Thus, two stimuli in a combination provides four possible different combinations as with sequence 800. Likewise, using three stimuli in a combination, each to be placed under its own sensor, would provide eight different stimuli combinations, and so forth. The combinations may be placed in any order as long as any transition from frame to frame (and in turn, between different combinations) within the repeated sequence provides a unique set of sensor sample value changes compared to the transition between any other combinations within the repeated sequence. For example, the transition from frame N to frame N+1 provides sensor sample value changes from (0, 0) to (0, 1) versus the transition from frame N+1 to N+2 that provides a change from (0, 1) to (1, 1). Thus, it can be determined that a frame is out of order when the expected sensor sample value changes are not provided at a particular transition between frames.

It will be appreciated that any of these frame characteristics may be provided by an on-screen transition measurement tool alone or combined with the one or more of the frame characteristic determinations described or others, and may or may not be provided as options to a user. Such selection could be provided on a setup screen on one of the devices that communicates with or has a transition detection unit.

Measurement tools built using the methods disclosed herein enable true end to end on-screen performance measurements that may be used for performance analysis of wireless display and PANs, such as Miracast, and wireless docking. Scaling these low cost, accurate tools to the ecosystem enables creation of the best performance and viewing experience on many different platforms.

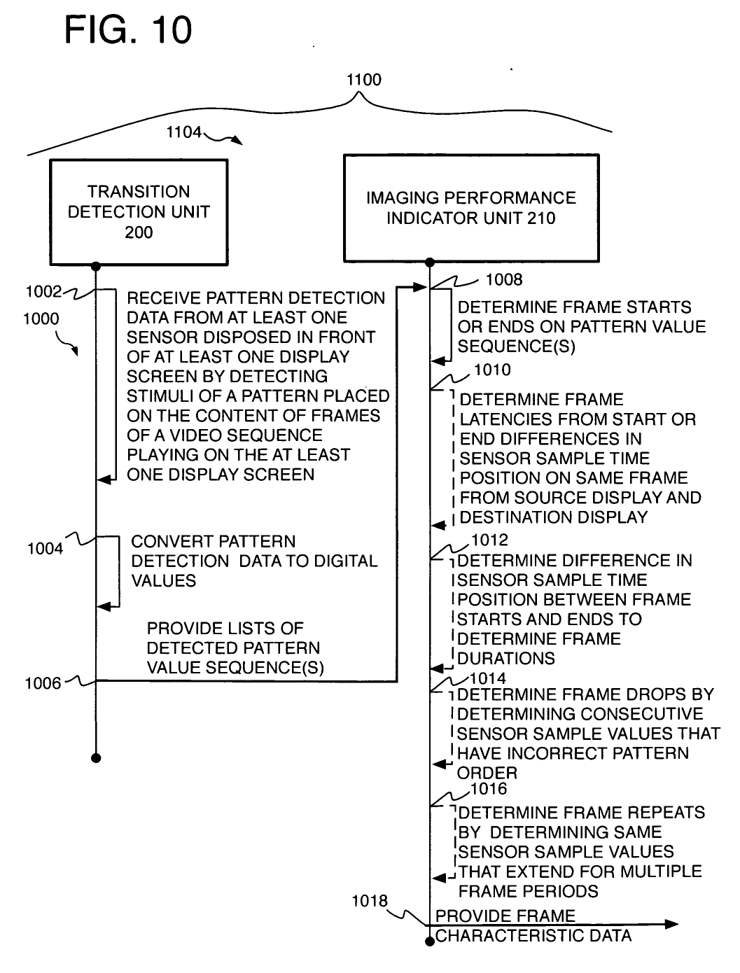

Referring to FIG. 10, by another approach, process 1000 illustrates the operation of a sample on-screen transition measurement system 1000 that uses sensors placed in front of a display screen showing a video sequence with one or more patterns and to provide pattern detection data used to show frame characteristics and in turn imaging performance indicators. In more detail, in the illustrated form, process 1000 may include one or more operations, functions or actions as illustrated by one or more of actions 1002 to 1018 numbered evenly. By way of non-limiting example, process 1000 will be described herein with reference to FIGS. 1, 2, and 11. Specifically, system 1100 includes logic units 1104 including a transition detection unit 200 and optionally an imaging performance indicator unit 210. The operation of the systems 100, 200, and 1100 may proceed as follows.

Process 1000 may include “receive pattern detection data from at least one sensor disposed in front of at least one display screen by detecting stimuli of a pattern placed on the content of frames of a video sequence playing on the at least one display screen” 1002. As described in detail above, this includes placing sensor units in front of display screens where patterns will be shown as part of the content of frames of a video sequence. This may include placing two sensors on two different displays or placing both sensors on a single display as described above.

Process 1000 may include “convert pattern detection data to digital values” 1004, and once the sensor data is obtained, it is converted into detected pattern sequence lists (one list for each sensor and each pattern for example). A stimulus of a pattern may be provided for the same area of each frame (or other interval of frames) in a video sequence and in alternating black and white (in color or grayscale) pattern that digitizes to 1 or 0 as detected by a sensor, where every change between 0 and 1 indicates a transition in color or grayscale of the pattern on the display screen. Other details are provided above.

Process 1000 may include “provide lists of detected pattern value sequence(s)” 1006. Thus, the detected pattern sequence lists may be provided to an imaging performance indicator unit that uses the lists to determine frame characteristics of the frames of the rendered video sequence. Other details are provided above.

Process 1000 may include “determine frame starts or ends on pattern value sequence(s)” 1008. Also as described in detail above, the change along each detected pattern sequence list between 1 and 0 among the sensor sample values on the list is noted as a transition from one color to another, and in turn a change from one frame to another.

Process 1000 may include “determine frame latencies from start or end differences in sensor sample time position on same frame from source display and destination display” 1010. This is applied to PAN or other systems with multiple display devices, each with its own sensor placed in front of its screen. These operations determine the difference in time between the time point a frame started (or ended) indicated by a sensor sample with a certain value relative to other sensor sample values near that sensor sample value along a sequence of such values and for one display device, and the sensor sample time point of a sensor sample with a similar indication on another display playing the same sequence. In one case, the sensor sample value will be the last or first value of a run of the same values among the subsequent or previous sensor sample values as explained in detail above.

Process 1000 may include “determine difference in sensor sample time position between frame starts and ends to determine frame durations” 1012. As with operation 1008, the start and end points of the frames along the detected pattern sequence lists may be found, and the time points represented by those sensor samples may be differenced to determine frame durations. Any duration longer than the expected frame period is either a lingering frame (when the extra duration is less than an entire frame period) or frame repeats described in detail above and mentioned below. This may be performed whether two or more sensors are on one display, or multiple displays are provided each with a sensor as described above as well.

Process 1000 may include “determine frame drops by determining consecutive sensor sample values that have incorrect order” 1014. Thus, when multiple patterns are provided on a single display device, it can be determined when a frame has been dropped since an unexpected sensor sample value combination is found at sensor sample change points (where values change between 1 and 0) on the detected pattern sequence lists as explained in detail above.

Process 1000 may include “determine frame repeats by determining same sensor sample values that extend for multiple frame periods” 1016. As with frame duration, the difference in time points between the sensor sample at a start of a frame and at an end of a frame are determined, and when this difference in time is greater than a single frame period by multiple extra frame periods, each of these extra frame periods is considered a frame repeat. The details are provided above.

Process 1000 may include “provide frame characteristic data” 1018, and the frame characteristic data may be provided to determine the quality of the image processing used to display the video sequence with the patterns in the content of the frames as described above. Thus, the user may compare video sequences of different imaging processes and determine which imaging process provides the smallest latency, most correct frame durations, and least frame drops or repeats.

It will be appreciated that processes 300, 400, and/or 1000 may be provided to operate at least some implementations of the present disclosure. In addition, any one or more of the operations of FIGS. 3, 4, and 10 may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more of the operations of the example processes herein in response to program code and/or instructions or instruction sets conveyed to the processor by one or more computer or machine-readable media. In general, a machine-readable medium may convey software in the form of program code and/or instructions or instruction sets that may cause any of the devices and/or systems to perform as described herein. The machine or computer readable media may be a non-transitory article or medium, such as a non-transitory computer readable medium, and may be used with any of the examples mentioned above or other examples except that it does not include a transitory signal per se. It does include those elements other than a signal per se that may hold data temporarily in a “transitory” fashion such as RAM and so forth.

As used in any implementation described herein, the term “module” refers to any combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth. For example, a module may be embodied in logic circuitry for the implementation via software, firmware, or hardware of the coding systems discussed herein.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

Referring to FIG. 11, an example imaging performance measurement system (or on-screen transition measurement system) 1100 is arranged in accordance with at least some implementations of the present disclosure. In various implementations, the example system 1100 may have sensor port (s) 1101 to form or receive sensor signal data such as the detected pattern sequences described above. This can be implemented in various ways. Thus, in one form, the measurement system 1100 is a device, or is on a device, connected to a number of sensor units mounted on a video display screen (or otherwise able to be placed in front of a display screen). In other examples, the system 1100 may be in communication with one or a network of sensors, and may be more remote from these sensors such that logic modules 1104 may communicate remotely with, or otherwise may be communicatively coupled to, the sensors for further processing of the detected sensor data. By yet other options, the system 1100 may be disposed on (as part of) one of the sensor units, or may be on a device (within the same outer body) as one or more of the sensor units.

In any of these cases, the system may be, or may be part of, a telephone, a smart phone, a tablet, a desk top computer, a laptop, a server, or any other computing device, and very well may be part of one of the display devices that the system is monitoring. As mentioned, the sensor docks may be connected to wires from sensor units. Otherwise, an antenna 1103 may be used to wirelessly receive sensor data.

In the illustrated example, a processing unit 1102 may be provided and that provides logic circuitry or modules 1104. The logic circuitry 1104 may include a transition detection unit 200 and an imaging performance indicator unit 210 which may or may not be within the same body or same hand-held device as the transition detection unit 200, and as described above. The operations of these components are described in detail above.

The system 1100 may have one or more processors or CPUs 1106 which may include an image signal processor (ISP) 1114, such as an Intel Atom, and which may or may not be dedicated to on-screen transition measurement processing, a graphics processing unit(s) 1108, memory store(s) 1110 which may or may not hold the saved detected pattern sequence lists described above, optionally at least one or more displays 1112 to provide images of performance data as desired, and antenna 1103 as already mentioned above. In one example implementation, the image processing system 1100 may have the sensor port(s) 1101, antennas 1103, at least one processor 1106 or 1108 communicatively coupled to the sensor port(s) 1101, and at least one memory 1110 communicatively coupled to the processor. The antenna 1103 also may be provided to transmit or receive other commands or sensor data to and from the device 1100 or other devices. As illustrated, any of these components may be capable of communication with one another and/or communication with portions of logic modules 1104. Thus, processors 1106 or 1108 may be communicatively coupled to the sensor docks 1101 and/or antenna 1103, the logic modules 1104, and the memory 1110 for operating the components of the logic modules 1104.

Although the system 1100, as shown in FIG. 11, may include one particular set of blocks or actions associated with particular components or modules, these blocks or actions may be associated with different components or modules than the particular component or module illustrated here.

Referring to FIG. 12, an example system 1200 in accordance with the present disclosure operates one or more aspects of the on-screen transition measurement system described herein and may be a separate on-screen transition measurement system or may be part of another system or device such as one of the display devices being monitored by the sensor units, and may be part of, or on, either a transmitter (source) display device or a receiver (sink) destination display device remote from the source as described herein. It will be understood from the nature of the system components described below that such components may be associated with, or used to operate, certain part or parts of the on-screen transition measurement system described above. In various implementations, system 1200 may be part of a media system although system 1200 is not limited to this context. For example, system 1200 may be incorporated into, or may be a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth, but otherwise any device communicating with sensor units described above, and often may have its own display device as well.

In various implementations, system 1200 includes a platform 1202 coupled to a display 1220. Platform 1202 may receive content from a content device such as content services device(s) 1230 or content delivery device(s) 1240 or other similar content sources. A navigation controller 1250 including one or more navigation features may be used to interact with, for example, platform 1202, and/or display 1120. Each of these components is described in greater detail below.

In various implementations, platform 1202 may include any combination of a chipset 1205, processor 1214, memory 1212, storage 1211, graphics subsystem 1215, applications 1216 and/or radio 1218. Chipset 1205 may provide intercommunication among processor 1214, memory 1212, storage 1211, graphics subsystem 1215, applications 1216 and/or radio 1218. For example, chipset 1205 may include a storage adapter (not depicted) capable of providing intercommunication with storage 1211.

Processor 1214 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1214 may be dual-core processor(s), dual-core mobile processor(s), and so forth.

Memory 1212 may be implemented as a volatile memory device such as, but not limited to, a Random Access Memory (RAM), Dynamic Random Access Memory (DRAM), or Static RAM (SRAM).

Storage 1211 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1211 may include technology to increase the storage performance enhanced protection for valuable digital media when multiple hard drives are included, for example.

Graphics subsystem 1215 may perform processing of images such as still or video for display. Graphics subsystem 1215 may be a graphics processing unit (GPU) or a visual processing unit (VPU), for example. An analog or digital interface may be used to communicatively couple graphics subsystem 1215 and display 1220. For example, the interface may be any of a High-Definition Multimedia Interface, Display Port, wireless HDMI, and/or wireless HD compliant techniques. Graphics subsystem 1215 may be integrated into processor 1214 or chipset 1205. In some implementations, graphics subsystem 1215 may be a stand-alone card communicatively coupled to chipset 1205.

The performance measurement processing techniques described herein may be implemented in various hardware architectures. For example, sensor data processing functionality may be integrated within a chipset. Alternatively, a discrete sensor data processor may be used. As still another implementation, the sensor data processing functions may be provided by a general purpose processor, including a multi-core processor. In further implementations, the functions may be implemented in a consumer electronics device.

Radio 1218 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), wireless display (WiDis) to establish Pan or mirroring networks, cellular networks, and satellite networks. In communicating across such networks, radio 1118 may operate in accordance with one or more applicable standards in any version.

In various implementations, display 1220 may include any television, computer, or other type of monitor or display. Display 1220 may include, for example, a computer display screen, touch screen display, video monitor, tablet or smartphone screen, and so forth. Display 1120 may be digital and/or analog. In various implementations, display 1120 may be a holographic display. Also, display 1120 may be a transparent surface that may receive a visual projection. Such projections may convey various forms of information, images, and/or objects. For example, such projections may be a visual overlay for a mobile augmented reality (MAR) application. Under the control of one or more software applications 1216, platform 1202 may display user interface 1222 on display 1220.

In various implementations, content services device(s) 1230 may be hosted by any national, international and/or independent service and thus accessible to platform 1202 via the Internet, for example. Content services device(s) 1230 may be coupled to platform 1202 and/or to display 1220. Platform 1202 and/or content services device(s) 1230 may be coupled to a network 1260 to communicate (e.g., send and/or receive) media information to and from network 1260. Content delivery device(s) 1240 also may be coupled to platform 1202, and/or to display 1220.

In various implementations, content services device(s) 1230 may include a network of display devices, sensor units, a cable television box, personal computer, network, telephone, Internet enabled devices or appliance capable of delivering digital information and/or content, and any other similar device capable of unidirectionally or bidirectionally communicating content between content providers and platform 1202, and/or display 1220, via network 1260 or directly. It will be appreciated that the content may be communicated unidirectionally and/or bidirectionally to and from any one of the components in system 1200 and a content provider via network 1260. Examples of content may include any media information including, for example, video, music, medical and gaming information, and so forth.

Content services device(s) 1230 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1202 may receive control signals from navigation controller 1250 having one or more navigation features. The navigation features of controller 1250 may be used to interact with user interface 1222, for example. In implementations, navigation controller 1250 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1250 may be replicated on a display (e.g., display 1220) by movements of a pointer, cursor, focus ring, or other visual indicators displayed on the display or by audio commands. For example, under the control of software applications 1216, the navigation features located on navigation controller 1250 may be mapped to virtual navigation features displayed on user interface 1222, for example. In implementations, controller 1250 may not be a separate component but may be integrated into platform 1202, speaker subsystem 1260, microphone subsystem 1270, and/or display 1220. The present disclosure, however, is not limited to the elements or in the context shown or described herein.

In various implementations, drivers (not shown) may include technology to enable users to instantly turn on and off platform 1202 like a television with the touch of a button after initial boot-up, when enabled, for example, or by auditory command. Program logic may allow platform 1202 to stream content to media adaptors or other content services device(s) 1230 or content delivery device(s) 1240 even when the platform is turned “off.” In addition, chipset 1205 may include hardware and/or software support for 8.1 surround sound audio and/or high definition (7.1) surround sound audio, for example. Drivers may include an auditory or graphics driver for integrated auditory or graphics platforms. In implementations, the auditory or graphics driver may comprise a peripheral component interconnect (PCI) Express graphics card.

In various implementations, any one or more of the components shown in system 1100 may be integrated. For example, platform 1202 and content services device(s) 1230 may be integrated, or platform 1202 and content delivery device(s) 1240 may be integrated, or platform 1202, content services device(s) 1230, and content delivery device(s) 1240 may be integrated, for example. In various implementations, platform 1202, and/or display 1220 may be an integrated unit. Display 1220, and content service device(s) 1230 may be integrated, or display 1220, and content delivery device(s) 1240 may be integrated, for example. These examples are not meant to limit the present disclosure.

In various implementations, system 1200 may be implemented as a wireless system, a wired system, or a combination of both. When implemented as a wireless system, system 1200 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1200 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1202 may establish one or more logical or physical channels to communicate information. The information may include media information and control information. Media information may refer to any data representing content meant for a user. Examples of content may include, for example, data from a voice conversation, videoconference, streaming video and audio, electronic mail (“email”) message, voice mail message, alphanumeric symbols, graphics, image, video, audio, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 12.

The on-screen transition measurement system described herein may be implemented as a mobile computing device having both wireless capabilities while wired to sensor units, and may refer to any device having a processing system and a mobile power source or supply, such as one or more batteries, for example. As described above, examples of a mobile computing device may include any device with a video sub-system such as a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, speaker system, and/or microphone system or network.

Examples of a mobile computing device for the display device may include computers that are arranged to be worn by a person, such as a head-phone, head band, hearing aide, wrist computer, finger computer, ring computer, eyeglass computer, belt-clip computer, arm-band computer, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context as long as the device has a display screen.

Various forms of the devices and processes described herein may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further implementations.

By one implementation, a computer-implemented method comprises A computer-implemented method of measuring on-screen transitions comprises receiving pattern detection data from at least one light sensor mounted to a front of at least one display screen displaying frames of a video sequence, wherein the individual frames have content with at least one color or luminance pattern that continues from frame-to-frame and that has at least one pattern stimulus positioned on the frames to be displayed in proximity to the light sensor(s); and determining frame characteristics by using the pattern detection data to determine a light level of at least one of the pattern stimuli on individual frames.

The method also may comprise wherein the at least one light sensor comprises at least one photodiode to detect the light; wherein the pattern is a substantially same area from frame to frame that changes color or luminance or both from frame to frame; wherein the frame characteristics are computed without using data from the device displaying the video sequence; and the method comprises receiving pattern detection data both from at least one light sensor at a source display device displaying the video sequence and at least one light sensor at a destination display device displaying the video sequence as transmitted from the source display device; and at least one of: (1) determining a frame latency from a time of rendering of a frame on the source display device to the time of displaying the frame on the destination display device by using the pattern detection data, wherein a single pattern stimulus of a single pattern is placed on a frame, and wherein the pattern is an alternating pattern of black and white, or substantially minimal light intensity to a substantially maximum light intensity, stimulus from frame-to-frame; and (2) displaying multiple patterns on a single display screen wherein each pattern has its own stimulus on the frame, and providing multiple light sensors with at least one light sensor at each stimulus on the frame, wherein at least one of the stimuli of the two patterns changes from frame to frame;

The method, while displaying multiple patterns on a single display, also comprises using a repeating sequence of multiple stimuli combinations, wherein one combination is disposed on a frame, and wherein the number of combinations in the repeating sequence depends on the number of stimuli in a combination; wherein the frame to frame order of the combinations in the repeated sequence is set so that each transition from frame to frame provides a unique change in sensor sample values relative to any other transition from frame to frame within the repeated sequence; wherein there are two of the patterns cooperatively providing two stimuli on individual frames, and wherein the patterns comprise a repeating sequence for four consecutive frames that includes four different two-stimuli combinations of color or light intensity: white-white, black-white, black-black, white-black, and considering the position of the stimuli to each other; and wherein the content of the patterns is transmitted from a source display device to a destination display device where the light sensors are mounted.

The method also may comprise determining at least one frame duration that a frame was displayed by determining the time points of a first sensor sample value and a last sensor sample value with the same sensor sample value in a run of the sensor sample values; determining whether a frame was dropped by determining whether consecutive sensor sample values indicate a pattern sequence that is out of order; determining whether a frame was repeated by determining whether the same pattern stimuli are provided over a number of extra sensor samples that is greater than the number of sensor samples that is expected to cover the display of at least one extra frame period; and converting an analog light sensor signal to a digital 1 or 0 to indicate black or white, or dark or light for individual stimuli of the pattern.

By another implementation, a system of measuring on-screen transitions comprising at least one memory; at least one processor communicatively connected to the at least one memory; and a transition detection unit operated by the at least one processor and to be communicatively connected to at least one sensor unit to: receive pattern detection data from the at least one sensor unit mounted to a front of at least one display screen displaying frames of a video sequence, wherein the individual frames have content with at least one color or luminance pattern that continues from frame-to-frame and that has at least one pattern stimulus positioned on the frames to be displayed in proximity to the sensor unit(s); and determine frame characteristics by using the pattern detection data to determine a light level of at least one of the pattern stimuli and on individual frames.

By yet another implementation, a system of wherein the at least one light sensor comprises at least one photodiode to detect the light; wherein the pattern is a substantially same area from frame to frame that changes color or luminance or both from frame to frame; wherein the frame characteristics are computed without using data from the device displaying the video sequence; and the transition detection unit may be arranged to receive pattern detection data both from at least one light sensor at a source display device displaying the video sequence and at least one light sensor at a destination display device displaying the video sequence as transmitted from the source display device; and at least one of: determine a frame latency from a time of rendering of a frame on the source display device to the time of displaying the frame on the destination display device by using the pattern detection data, wherein a single pattern stimulus of a single pattern is placed on a frame, and wherein the pattern is an alternating pattern of black and white, or substantially minimal light intensity to a substantially maximum light intensity, stimulus from frame-to-frame; and display multiple patterns on a single display screen wherein each pattern has its own stimulus on the frame, and providing multiple light sensors with at least one light sensor at each stimulus on the frame, wherein at least one of the stimuli of the two patterns changes from frame to frame.

The transition detection unit being arranged to, while displaying multiple patterns on a single display, use a repeating sequence of multiple stimuli combinations, wherein one combination is disposed on a frame, and wherein the number of combinations in the repeating sequence depends on the number of stimuli in a combination; wherein the frame to frame order of the combinations in the repeated sequence is set so that each transition from frame to frame provides a unique change in sensor sample values relative to any other transition from frame to frame within the repeated sequence; wherein there are two of the patterns cooperatively providing two stimuli on individual frames, and wherein the patterns comprise a repeating sequence for four consecutive frames that includes four different two-stimuli combinations of color or light intensity: white-white, black-white, black-black, white-black, and considering the position of the stimuli to each other; and wherein the content of the patterns is transmitted from a source display device to a destination display device where the light sensors are mounted.

The transition detection unit being arranged to determine at least one frame duration that a frame was displayed by determining the time points of a first sensor sample value and a last sensor sample value with the same sensor sample value in a run of the sensor sample values; determine whether a frame was dropped by determining whether consecutive sensor sample values indicate a pattern sequence that is out of order; determine whether a frame was repeated by determining whether the same pattern stimuli are provided over a number of extra sensor samples that is greater than the number of sensor samples that is expected to cover the display of at least one extra frame period; and convert an analog light sensor signal to a digital 1 or 0 to indicate black or white, or dark or light for individual stimuli of the pattern.

By another option, a system of measuring on-screen transitions comprises at least one sensor unit to be mounted to a front of at least one display screen displaying a color or luminance or both of a pattern formed by displaying frames of a video sequence, and in order to detect changes in the pattern, wherein the at least one sensor unit is arranged to transmit sensor signals to a transition detection unit to determine characteristics of the frames from the detected changes in the pattern and to detect at least one of: (1) a frame latency between the time a frame was displayed on a first display screen and a time a frame was displayed on a second display screen, (2) a frame duration indicating how long a frame was displayed on the display screen, and (3) a frame order indicating a consecutive order of the display of frames.

By another example, at least one computer readable medium comprises a plurality of instructions that in response to being executed on a computing device, causes the computing device to receive pattern detection data from at least one light sensor mounted to a front of at least one display screen displaying frames of a video sequence, wherein the individual frames have content with at least one color or luminance pattern that continues from frame-to-frame and that has at least one pattern stimulus positioned on the frames to be displayed in proximity to the light sensor(s); and determine frame characteristics by using the pattern detection data to determine a light level of at least one pattern stimuli and on individual frames.

The instructions also cause the computing device to wherein the at least one light sensor comprises at least one photodiode to detect the light; wherein the pattern is a substantially same area from frame to frame that changes color or luminance or both from frame to frame; wherein the frame characteristics are computed without using data from the device displaying the video sequence; wherein the instructions cause the computing device to: receive pattern detection data both from at least one light sensor at a source display device displaying the video sequence and at least one light sensor at a destination display device displaying the video sequence as transmitted from the source display device; and at least one of: determine a frame latency from a time of rendering of a frame on the source display device to the time of displaying the frame on the destination display device by using the pattern detection data, wherein a single pattern stimulus of a single pattern is placed on a frame, and wherein the pattern is an alternating pattern of black and white, or substantially minimal light intensity to a substantially maximum light intensity, stimulus from frame-to-frame; and display multiple patterns on a single display screen wherein each pattern has its own stimulus on the frame, and providing multiple light sensors with at least one light sensor at each stimulus on the frame, wherein at least one of the stimuli of the two patterns changes from frame to frame; wherein the instructions cause the computing device to, while displaying multiple patterns on a single display, use a repeating sequence of multiple stimuli combinations, wherein one combination is disposed on a frame, and wherein the number of combinations in the repeating sequence depends on the number of stimuli in a combination; wherein the frame to frame order of the combinations in the repeated sequence is set so that each transition from frame to frame provides a unique change in sensor sample values relative to any other transition from frame to frame within the repeated sequence; wherein there are two of the patterns cooperatively providing two stimuli on individual frames, and wherein the patterns comprise a repeating sequence for four consecutive frames that includes four different two-stimuli combinations of color or light intensity: white-white, black-white, black-black, white-black, and considering the position of the stimuli to each other; and wherein the content of the patterns is transmitted from a source display device to a destination display device where the light sensors are mounted.

The instructions also cause the computing device to determine at least one frame duration that a frame was displayed by determining the time points of a first sensor sample value and a last sensor sample value with the same sensor sample value in a run of the sensor sample values; determine whether a frame was dropped by determining whether consecutive sensor sample values indicate a pattern sequence that is out of order; determine whether a frame was repeated by determining whether the same pattern stimuli are provided over a number of extra sensor samples that is greater than the number of sensor samples that is expected to cover the display of at least one extra frame period; and convert an analog light sensor signal to a digital 1 or 0 to indicate black or white, or dark or light for individual stimuli of the pattern.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus, example systems, and/or example articles, and vice versa.

1. A computer-implemented method of measuring on-screen transitions comprising:
receiving pattern detection data from at least two light sensors mounted to a front of one display screen displaying frames of a video sequence,
wherein each light sensor has a mounting structure forming a separate light excluding chamber,
wherein the individual frames have content with at least one color or luminance pattern that continues from frame-to-frame, wherein the pattern is less than the full size of the frame, and has at least one pattern stimulus positioned and sized on the frames to be displayed in proximity to the light sensor(s) and within each chamber; and
determining frame characteristics by using the pattern detection data to determine a light level of at least one of the pattern stimuli on individual frames.

2. The method of claim 1 wherein the at least one light sensor comprises at least one photodiode to detect the light.

3. The method of claim 1 wherein the pattern is a substantially same area from frame to frame that changes color or luminance or both from frame to frame.

4. The method of claim 1 wherein the light excluding chambers are formed within the same single suction cup.

5. The method of claim 1 comprising:
receiving pattern detection data both from at least one light sensor at a source display device displaying the video sequence and at least one light sensor at a destination display device displaying the video sequence as transmitted from the source display device; and
determining a frame latency from a time of rendering of a frame on the source display device to the time of displaying the frame on the destination display device by using the pattern detection data.

6. The method of claim 1 wherein a single pattern stimulus of a single pattern is placed on a frame, and wherein the pattern is an alternating pattern of black and white, or substantially minimal light intensity to a substantially maximum light intensity, stimulus from frame-to-frame.

7. The method of claim 1 comprising displaying multiple patterns on a single display screen wherein each pattern has its own stimulus on the frame, and providing the light sensors with at least one light sensor at each stimulus on the frame.

8. The method of claim 7 wherein at least one of the stimuli of the two patterns changes from frame to frame.

9. The method of claim 7 comprising using a repeating sequence of multiple stimuli combinations, wherein one combination is disposed on a frame, and wherein the number of combinations in the repeating sequence depends on the number of stimuli in a combination.

10. The method of claim 7 comprising using a repeating sequence of multiple stimuli combinations, wherein one combination is disposed on a frame, and wherein the frame to frame order of the combinations in the repeated sequence is set so that each transition from frame to frame provides a unique change in sensor sample values relative to any other transition from frame to frame within the repeated sequence.

11. The method of claim 7 wherein there are two of the patterns cooperatively providing two stimuli on individual frames, and wherein the patterns comprise a repeating sequence for four consecutive frames that includes four different two-stimuli combinations of color or light intensity: white-white, black-white, black-black, white-black, and considering the position of the stimuli to each other.

12. The method of claim 7 wherein the content of the patterns is transmitted from a source display device to a destination display device where the light sensors are mounted.

13. The method of claim 1 comprising determining at least one frame duration that a frame was displayed by determining the time points of a first sensor sample value and a last sensor sample value with the same sensor sample value in a run of the sensor sample values.

14. The method of claim 1 comprising determining whether a frame was dropped by determining whether consecutive sensor sample values indicate a pattern sequence that is out of order.

15. The method of claim 1 comprising determining whether a frame was repeated by determining whether the same pattern stimuli are provided over a number of extra sensor samples that is greater than the number of sensor samples that is expected to cover the display of at least one extra frame period.

16. The method of claim 1 comprising converting an analog light sensor signal to a digital 1 or 0 to indicate black or white, or dark or light for individual stimuli of the pattern.

17. The method of claim 1 wherein the at least one light sensor comprises at least one photodiode to detect the light;
wherein the pattern is a substantially same area from frame to frame that changes color or luminance or both from frame to frame;
the method comprising receiving pattern detection data both from at least one light sensor at a source display device displaying the video sequence and at least one light sensor at a destination display device displaying the video sequence as transmitted from the source display device;
at least one of:
(1) determining a frame latency from a time of rendering of a frame on the source display device to the time of displaying the frame on the destination display device by using the pattern detection data, wherein a single pattern stimulus of a single pattern is placed on a frame, and wherein the pattern is an alternating pattern of black and white, or substantially minimal light intensity to a substantially maximum light intensity, stimulus from frame-to-frame; and
(2) displaying multiple patterns on a single display screen wherein each pattern has its own stimulus on the frame, and providing multiple light sensors with at least one light sensor at each stimulus on the frame, wherein at least one of the stimuli of the two patterns changes from frame to frame;
the method while displaying multiple patterns on a single display comprises using a repeating sequence of multiple stimuli combinations, wherein one combination is disposed on a frame, and wherein the number of combinations in the repeating sequence depends on the number of stimuli in a combination;
wherein the frame to frame order of the combinations in the repeated sequence is set so that each transition from frame to frame provides a unique change in sensor sample values relative to any other transition from frame to frame within the repeated sequence;
wherein there are two of the patterns cooperatively providing two stimuli on individual frames, and wherein the patterns comprise a repeating sequence for four consecutive frames that includes four different two-stimuli combinations of color or light intensity: white-white, black-white, black-black, white-black, and considering the position of the stimuli to each other; and
wherein the content of the patterns is transmitted from a source display device to a destination display device where the light sensors are mounted;
determining at least one frame duration that a frame was displayed by determining the time points of a first sensor sample value and a last sensor sample value with the same sensor sample value in a run of the sensor sample values;
determining whether a frame was dropped by determining whether consecutive sensor sample values indicate a pattern sequence that is out of order;
determining whether a frame was repeated by determining whether the same pattern stimuli are provided over a number of extra sensor samples that is greater than the number of sensor samples that is expected to cover the display of at least one extra frame period; and
converting an analog light sensor signal to a digital 1 or 0 to indicate black or white, or dark or light for individual stimuli of the pattern.

18. A system of measuring on-screen transitions comprising:
at least one memory;
at least one processor communicatively connected to the at least one memory; and
a transition detection unit operated by the at least one processor and to be communicatively connected to at least one sensor unit to:
receive pattern detection data from at least two light sensors mounted to a front of one display screen displaying frames of a video sequence,
wherein each light sensor has a mounting structure forming a separate light excluding chamber,
wherein the individual frames have content with at least one color or luminance pattern that continues from frame-to-frame, wherein the pattern is less than the full size of the frame, and has at least one pattern stimulus positioned and sized on the frames to be displayed in proximity to the light sensor(s) and within each chamber; and
determine frame characteristics by using the pattern detection data to determine a light level of at least one of the pattern stimuli on individual frames.

19. The system of claim 18 wherein the at least one light sensor comprises at least one photodiode to detect the light;
wherein the pattern is a substantially same area from frame to frame that changes color or luminance or both from frame to frame;
the transition detection unit arranged to receive pattern detection data both from at least one light sensor at a source display device displaying the video sequence and at least one light sensor at a destination display device displaying the video sequence as transmitted from the source display device;
at least one of:
(1) determine a frame latency from a time of rendering of a frame on the source display device to the time of displaying the frame on the destination display device by using the pattern detection data, wherein a single pattern stimulus of a single pattern is placed on a frame, and wherein the pattern is an alternating pattern of black and white, or substantially minimal light intensity to a substantially maximum light intensity, stimulus from frame-to-frame; and
(2) display multiple patterns on a single display screen wherein each pattern has its own stimulus on the frame, and providing the light sensors with at least one light sensor at each stimulus on the frame, wherein at least one of the stimuli of the two patterns changes from frame to frame;
the transition detection unit being arranged to, while displaying multiple patterns on a single display, use a repeating sequence of multiple stimuli combinations, wherein one combination is disposed on a frame, and wherein the number of combinations in the repeating sequence depends on the number of stimuli in a combination;
wherein the frame to frame order of the combinations in the repeated sequence is set so that each transition from frame to frame provides a unique change in sensor sample values relative to any other transition from frame to frame within the repeated sequence;
wherein there are two of the patterns cooperatively providing two stimuli on individual frames, and wherein the patterns comprise a repeating sequence for four consecutive frames that includes four different two-stimuli combinations of color or light intensity: white-white, black-white, black-black, white-black, and considering the position of the stimuli to each other; and
wherein the content of the patterns is transmitted from a source display device to a destination display device where the light sensors are mounted;
determine at least one frame duration that a frame was displayed by determining the time points of a first sensor sample value and a last sensor sample value with the same sensor sample value in a run of the sensor sample values;
determine whether a frame was dropped by determining whether consecutive sensor sample values indicate a pattern sequence that is out of order;
determine whether a frame was repeated by determining whether the same pattern stimuli are provided over a number of extra sensor samples that is greater than the number of sensor samples that is expected to cover the display of at least one extra frame period; and
convert an analog light sensor signal to a digital 1 or 0 to indicate black or white, or dark or light for individual stimuli of the pattern.

20. A system of measuring on-screen transitions comprising:
at least two sensor units arranged to provide the option to be mounted to a front of either one same display or respectively on two separate displays, wherein each display having a display screen displaying a color or luminance or both of a pattern formed by displaying frames of a video sequence, and in order to detect changes in the pattern; and
a transition detection unit communicatively coupled to the at least two sensors, and arranged to receive transmitted sensor signals from the at least two sensor units to determine characteristics of the frames from the detected changes in the pattern and to provide the option to detect alone or in any combination of:
(1) a frame latency between the time a frame was displayed on a first display screen and a time a frame was displayed on a second display screen,
(2) a frame duration indicating how long a frame was displayed on the display screen, and
(3) a frame order indicating a consecutive order of the display of frames.

21. (canceled)

22. The system of claim 20 wherein each sensor unit has a body that is a suction cup arranged to be mounted on the screen of the display and at least one photodiode mounted within the suction cup.

23. The system of claim 20 wherein all three options (1), (2), and (3) are performed while two of the sensor units are mounted on the one same display.

24. At least one non-transitory computer readable medium comprising a plurality of instructions that in response to being executed on a computing device, causes the computing device to:
receive pattern detection data from at least two light sensors mounted to a front of one display screen displaying frames of a video sequence,
wherein each light sensor has a mounting structure forming a separate light excluding chamber,
wherein the individual frames have content with at least one color or luminance pattern that continues from frame-to-frame, wherein the pattern is less than the full size of the frame, and has at least one pattern stimulus positioned and sized on the frames to be displayed in proximity to the light sensor(s) and within each chamber; and
determine frame characteristics by using the pattern detection data to determine a light level of at least one of the pattern stimuli on individual frames.

25. The medium of claim 24, wherein the at least one light sensor comprises at least one photodiode to detect the light;
wherein the pattern is a substantially same area from frame to frame that changes color or luminance or both from frame to frame;
wherein the instructions cause the computing device to:
receive pattern detection data both from at least one light sensor at a source display device displaying the video sequence and at least one light sensor at a destination display device displaying the video sequence as transmitted from the source display device;
at least one of:
(1) determine a frame latency from a time of rendering of a frame on the source display device to the time of displaying the frame on the destination display device by using the pattern detection data, wherein a single pattern stimulus of a single pattern is placed on a frame, and wherein the pattern is an alternating pattern of black and white, or substantially minimal light intensity to a substantially maximum light intensity, stimulus from frame-to-frame; and
(2) display multiple patterns on a single display screen wherein each pattern has its own stimulus on the frame, and providing the light sensors with at least one light sensor at each stimulus on the frame, wherein at least one of the stimuli of the two patterns changes from frame to frame;
wherein the instructions cause the computing device to, while displaying multiple patterns on a single display, use a repeating sequence of multiple stimuli combinations, wherein one combination is disposed on a frame, and wherein the number of combinations in the repeating sequence depends on the number of stimuli in a combination;
wherein the frame to frame order of the combinations in the repeated sequence is set so that each transition from frame to frame provides a unique change in sensor sample values relative to any other transition from frame to frame within the repeated sequence;
wherein there are two of the patterns cooperatively providing two stimuli on individual frames, and wherein the patterns comprise a repeating sequence for four consecutive frames that includes four different two-stimuli combinations of color or light intensity: white-white, black-white, black-black, white-black, and considering the position of the stimuli to each other; and
wherein the content of the patterns is transmitted from a source display device to a destination display device where the light sensors are mounted;
determine at least one frame duration that a frame was displayed by determining the time points of a first sensor sample value and a last sensor sample value with the same sensor sample value in a run of the sensor sample values;
determine whether a frame was dropped by determining whether consecutive sensor sample values indicate a pattern sequence that is out of order;
determine whether a frame was repeated by determining whether the same pattern stimuli are provided over a number of extra sensor samples that is greater than the number of sensor samples that is expected to cover the display of at least one extra frame period; and
convert an analog light sensor signal to a digital 1 or 0 to indicate black or white, or dark or light for individual stimuli of the pattern.
